(19) United States
(12) Patent Application Publication
(10) Pub. No.: US 2020/0211032 A1
(43) Pub. Date: Jul. 2, 2020

(54) TAMPERPROOF, COUNTERFEITING RESISTANT PRODUCT LABEL

(71) Applicant: Noos Technologies Private Limited, Bangalore (IN)

(72) Inventor: KOUSHIK BANERJEE, Bangalore (IN)

(21) Appl. No.: 16/730,278

(22) Filed: Dec. 30, 2019

(30) Foreign Application Priority Data
Dec. 28, 2018 (IN) 201841049628

(51) Int. Cl. G06Q 30/00

(52) U.S. Cl. CPC G06Q 30/0185

(57) ABSTRACT

A tamperproof, counterfeiting resistant security label is envisaged. The security label includes a base layer, an adhesive layer applied atop the base layer, and a face stock positioned above the adhesive layer. The face stock essentially includes at least one scannable security element disposed thereon. The security element comprises an indicium positioned within the periphery of the face stock. The indicium is oriented with reference to the positioning of an invisible reference point situated within the periphery of the security label. The reference point, given its programmatic conceptualization and positioning is rendered invisible to naked human eye as well as to conventional scanning devices which have not been specifically pre-programmed to scan and identify otherwise invisible reference points. Positioning of the reference point and the positioning of the indicium put together forms a non-apparent, signature unique to the security label.

### CROSS-REFERENCE TO RELATED APPLICATIONS

This application claims priority to the Provisional Patent Application with serial number 201841049628, filed in the Indian Patent Office on Dec. 28, 2018, with the title “AUTHENTICATION THROUGH SIGNATURE LABEL”. The content of the Provisional Patent Application is incorporated in its entirety by reference herein.

### BACKGROUND

### Technical Field

The present disclosure generally relates to product labels affixed on products for identifying and conveying product-specific information to users. Particularly, the present disclosure relates to tamperproof, counterfeiting resistant product labels equipped with enhanced levels of security against tampering and counterfeiting. The present disclosure also relates to a method of conceptualizing and designing a tamperproof, counterfeiting resistant product label and a method of using such a product label for circumventing tampering and consequential counterfeiting of products.

### Description of the Related Art

Despite the technological advances in the fields of product packaging and product verification and authentication, tampering of product labels, and the consequential counterfeiting of underlying products continues unabated and remains a perennial problem. Traditional counterfeiting scenarios involve production, packaging, and selling or at least an attempt at selling inferior quality products emulating genuine offerings at least in terms of the outlook and packaging. Typically, counterfeit products are passed-off as genuine products, for they closely resemble their genuine counterpart's packaging and outlook, and on the outset appear to embody the features and functionalities of the genuine counterparts, the quality, durability, effectiveness and customer satisfaction attributed to genuine products notwithstanding. In most of the cases, the quality of counterfeited products is way below the quality of their genuine counterparts, but customers are deceived into buying them given their close emulation of the genuine counterparts and a possible substantial reduction in the pricing vis-à-vis the genuine counterparts. Counterfeiting, by its very nature, involves defrauding customers into believing the authenticity of the counterfeited products and provides customers with a false sense of accomplishment resulting from buying (counterfeit) products at a price much lower than the market standards. Counterfeiting has a profound impact not only on the consumers but also on the entities whose products are counterfeited, for such counterfeited products not only replace the superior quality genuine products but also tarnish the brand value and market goodwill associated with genuine superior quality products by not only conniving the consumers into buying counterfeited products believing them to be original but also deceiving the consumers into attributing, rather unwittingly, the lack of quality and customer support generally characterized by counterfeited products, to the genuine, superior quality products, for the consumers have been connived into believing the counterfeited products as original and genuine. Counterfeited products also bring about a downfall in the market share, goodwill, and revenue attributed to genuine products. The short-term and ostensibly shallow cost benefits of counterfeit products notwithstanding, they could have a catastrophic effect not only on the mindset and in certain cases the health of the end consumer, but also on the brand equity associated with organization and entities whose genuine products they replace.

Since counterfeit products have infiltrated nearly every field in global consumer markets and since they rip-off the name and goodwill associated with branded products by creating cheaper knock-offs, there is an immediate need to eliminate counterfeit products and also to circumvent creation and channelization of counterfeit products. The problem of counterfeiting, while rampant in the consumer goods industry, has spread to every profitable market segment, including automobiles, industrial equipment and spare parts, and healthcare and hygiene products. Since counterfeited products are always passed off as original and since even counterfeited products are in huge demand given their affordable pricing, the lack of quality and consumer support inter-alia notwithstanding, it is not only difficult to detect counterfeited products but also accurately quantify the extent of damages caused by counterfeiting. And the enormity of product counterfeiting can be gauged from the fact that globally counterfeit goods account for 300-600 Billion USD in trade value. In a reflection of the enormous market penetration enjoyed by counterfeit goods, it has been estimated that in certain market segments such as automobile spare parts, beverages, healthcare and hygiene products, the market supply and at times the market share of counterfeit goods far outruns that of the genuine counterparts. With the onset of globalization and the eventuality of product supply chains being well extended into countries that may not possess the necessary infrastructure to differentiate between counterfeited and genuine goods, it is imperative that a comprehensive anti-counterfeiting solution is made available for the menace that counterfeiting is.

Given how rampant counterfeiting has been, several techniques have been proposed in the prior art for preventing them. One of the notable and most common technique includes the use of product labels which attempt to differentiate a genuine product against its counterfeit. However, this approach has been largely ineffective given that such product labels could be tampered without much of an effort and (subsequently) re-affixed without even leaving a trace of tampering, thanks to the advancements achieved in printing technology and product packaging technology. Secondly, most of the end-consumers fail to understand the probability of a product label having been tampered and re-affixed post replacement of a genuine product with a counterfeited product. And therefore in such cases, it is imperative that counterfeiting of products has to be identified and such (counterfeited) products taken off the supply chain before they are made available to the end consumers. And in this regard, an attempt was made to embed each genuine product with a Radio Frequency Identification (RFID) tag, which would, in turn, transmit identification data unique to the underlying product, thereby facilitating a unique identification and thus an authentication of the genuineness of the product. However, the cost factor associated with the RFID tags, coupled with a possibility of RFID codes being electronically hacked and compromised, caused hindrances to the implementation of RFID based authentication process. And therefore, in view of the drawbacks discussed hitherto, there was felt a strong need for a tamperproof, counterfeiting resistant, cost-effective product label which was not only easy to produce but was also resistant to hacker attacks.

### OBJECTS

An object of the present disclosure is to envisage a tamperproof, counterfeiting resistant product label.

Yet another object of the present disclosure is to envisage a product label that incorporates enhanced security parameters, which, in turn, provide for instant detection of tampering of the product label.

Still, a further object of the present disclosure is to envisage a uniquely formulated product label whose underlying characterization would not be apparent to the naked human eye.

One more object of the present disclosure is to envisage a uniquely formulated product label whose underlying characterization would not be decipherable even by a scanning device which has not been specifically preconfigured to scan and read the said product label.

Another object of the present disclosure is to envisage a product label whose layout has been characterized strictly based on a reference parameter internal to the product label.

One more object of the present disclosure is to envisage a product label usable for determining the authenticity of a product, independent of other accompanying product-specific codes such as a bar code and a Quick Response (QR) code.

Yet another object of the present disclosure is to envisage a product label whose orientation and disposition on a product package is independent of the other product specific codes accompanying the product package, including a bar code and a Quick Response (QR) code.

Still, a further object of the present disclosure is to envisage a product label which, once tampered, could never be restored to its original form, given its characterization.

One more object of the present disclosure is to pre-program/configure a scanning device to ably identify and decipher the characteristics of the product label envisaged by the present disclosure.

Yet another object of the present disclosure is to envisage a product label that is verifiable and authenticatable independent of the corresponding product-specific codes accompanying the product package, including a bar code and a Quick Response (QR) code.

Still, a further object of the present disclosure is to envisage a product label that is impossible to be replicated given its characterization based on an invisible reference parameter internal to the product label.

### SUMMARY

The present disclosure envisages a tamperproof, counterfeiting resistant product label—also referred to as a security label given its tamperproof and counterfeiting resistant design and construction. The security label includes a base layer, an adhesive layer applied atop the base layer, and a face stock positioned above the adhesive layer, such that the face stock forms the upper or frontal surface of the base layer. Alternatively, instead of the adhesive layer applied upon the base layer, a rear surface (backside) of the face stock (also referred to as a label stock) could be coated with a self-adhesive layer, such that the face stock could be affixed onto a product package. In both of the aforementioned scenarios, the face stock essentially includes at least one security element disposed thereon, with the security element comprising at least one indicium positioned within the periphery of the face stock. Essentially, the dimension of the face stock is equivalent to the dimension of the entire product label, for the face stock is placed atop the base layer so as to overlap the base layer in its entirety. However, in an event where the dimensions of the base layer and the face stock are not equivalent, the face stock would be designed such that the dimension of the face stock is always lesser than the dimension of the base layer, and such that the face stock forms at least a part of the upper or frontal surface of the base layer. Essentially, the security element disposed on the face stock forms the scannable portion of the face stock and, by extension, the scannable portion of the security label.

The indicium (or the indicia) disposed on the frontal (or upper) surface of the base layer is essentially oriented with reference to the positioning of an invisible reference point situated within the periphery of the security label. The reference point is programmatically chosen during the process of designing and conceptualization of the security label, but with the criterion that the reference point thus chosen should always be disposed within the periphery of, and thus internal to the security label. The reference point thus chosen is stored in the form of a coordinate on a database. Further, based on the said coordinate denoting the positioning of the reference point within or on the periphery of the security label, the indicia are programmatically created and disposed within the periphery of the security label such that the positioning of the indicia could always be correlated either in terms of length or angular distance or both, thereby implicitly interlinking the positioning of the indicia with the positioning of the reference point and thereby ensuring that a change in the positioning of the former would also bring about a change in the positioning of the latter.

The security label envisaged by the present disclosure works on the principle that anything hidden from plain view or anything not apparent cannot be copied. The reference point, given its programmatic conceptualization and positioning, is rendered invisible to the naked human eye as well as to conventional scanning devices that have not been specifically pre-programmed to scan and identify otherwise invisible reference points. And since the reference point is rendered invisible to the naked human eye and conventional scanning devices, the correlation between the reference point and the indicia is also rendered invisible (to naked human key and conventional scanning devices). However, the positioning of the reference point within the periphery of the security label and the positioning of the indicia with reference to the positioning of the reference point are correlated and represented in the form of positional coordinates, with the positional coordinates forming a non-duplicable patten, and the non-duplicable pattern forming a signature unique to the security label and the product package on which the security label has been affixed. The unique signature represented by the corresponding positional coordinates is essentially stored in the database and (is) rendered accessible to scanning devices, which, in turn, have been pre-programmed to scan such product labels. Additionally, the unique signature characterizing the security label is programmatically linked to a product ID associated with the product (or the product package) on which the said product label is affixed, such that the product could be uniquely identified based on the corresponding product ID-unique signature information. Essentially, the database stores a plurality of product IDs interlinked with corresponding unique signatures, with each unique signature representing a unique product label affixed onto respective product packages represented by corresponding product IDs. Likewise, it is also possible that an entire batch of products are uniquely identified and authenticated based on a product ID-unique signature pair common to each of the products of the batch. And in such a case, each of the products in the batch would be affixed with the same security label and the same product ID, so that they (each of the products) entail the same product ID-unique signature pair.

And when the product package embodying the security label envisaged by the present disclosure is scanned by any of the scanning devices pre-programmed as discussed above, the scanning device identifies, ostensibly by way of scanning, the product ID of the product package, the dispositioning of the reference point within the periphery of the security label, the dispositioning of the indicia with reference to the positioning of the reference point, and constructs an inference between the dispositioning of the reference point and the dispositioning of the indicia, with the inference being represented either in terms of length or angular distance or both. Further, the inference constructed in terms of either length or angular distance or both is represented, by the scanning device, in the form of corresponding positional coordinates, which, in turn, are converted into a signature representative of the scanned product label.

And subsequently, the scanning device consults the database and determines if the product ID scanned from the product package is equivalent to a product ID stored in the database. And in case of a match between the product IDs, the scanning device determines if a corresponding unique signature stored on the database is equivalent to the signature representative of the scanned product label. And if the unique signature stored on the database along with a link to the namesake of the scanned product ID is determined to be equivalent to the signature representative of the scanned product label, then the scanning device confirms the security label (affixed on the product package) as authentic, untampered and genuine. Otherwise, an identification from the scanning device that the unique signature stored on the database along with a link to the namesake of the scanned product ID is not equivalent to the signature representative of the scanned product label, points to a possibility of positioning of the invisible reference point having been unwittingly disturbed/altered during the process of unauthorized removal and re-affixing of the product label, thus implying the tampering of security label and the possible counterfeiting of corresponding product.

### BRIEF DESCRIPTION OF THE ACCOMPANYING DRAWINGS

FIGS. 1A-1H illustrate design-related variations in the tamperproof, counterfeiting resistant product label, in accordance with the present disclosure;

FIGS. 2A-2B illustrate a method for conceptualizing and designing the tamperproof, counterfeiting resistant product label having at least one indicium, in accordance with the present disclosure; and

FIG. 3 illustrates a method for conceptualizing and designing the tamperproof, counterfeiting resistant product label having at least two indicia, in accordance with the present disclosure.

### DETAILED DESCRIPTION

The present disclosure envisages a tamperproof, counterfeiting resistant product label (also referred to as a security label, given its resilience to tampering and duplication), which, when applied onto any product package or product or both, facilitates a seamless identification of the authenticity thereof. In addition, the security label (the terms ‘security label’ and ‘product label’ are used interchangeably throughout the present disclosure and are intended to convey the same meaning) is characterized such that any tampering thereof is rendered evident from a simple and straight forward electronic inspection—by way of scanning—thereof. The security label envisaged by the present disclosure is applicable for products (or product packages), including but not restricted to electronic objects, confidential and sensitive documents, and any frequently traded items, which, in turn, entail comparatively long shipping hours and pass through multiple transit hubs.

Further, the security label envisaged by the present disclosure could also be affixed on consumer goods, including but not restricted to mobile phones, televisions, automobile spare parts, toys, and electronic media such as Compact Discs (CD) and Digital Video Discs (DVD). In essence, the security label could be used for protecting the authenticity of and preventing tampering and subsequent counterfeiting of any product that entails reasonable sale and re-sale value, enjoys market goodwill, entails brand recognition, and whose counterfeiting is likely to fetch reasonable undue financial, logistical, and product goodwill related advantages.

A typical effort towards counterfeiting entails tampering and subsequent resealing of a (prior-art) product label affixed onto a product. If the product is packaged, as is likely in the case of consumer goods such as televisions and mobile phones, counterfeiting involves tampering and resealing of the product label affixed upon the product package, typically followed by tampering and resealing of the product label affixed onto the product contained within the package. And an effort towards counterfeiting is deemed successful if an original product label affixed onto a product/product package is removed without any damages caused thereto, the genuine product is replaced by a counterfeit and certainly, in most of the cases, an inferior quality product, repackaged, and the original product label which was removed without any damages from the package is re-affixed onto the repackaged counterfeited product, thereby passing-off the repackaged counterfeited product as genuine. And given the technological advancements achieved in packaging technology, the task of re-affixing the original product label onto a counterfeit product no longer remains an arduous, time consuming, labor, and machinery intensive task. Yet another typical attempt at counterfeiting involves replacing an original product label and an underlying original product with a counterfeit/duplicate product label and a counterfeit, and most likely, an inferior quality product respectively. And given the technological advancements in printing technology and precision engineering of product labels, designing and printing a counterfeit product label mimicking the specifics of an original product label no longer remains an arduous and cumbersome task, and can be achieved within a short span of time and to greater levels of accuracy, the counterfeit-deterrent strategies employed during the manufacture of original product label notwithstanding.

And therefore, in order to obviate the possibility of either an original product label being tampered and successfully resealed/re-affixed after counterfeiting and thereby playing an inadvertent role in passing off the counterfeited product as genuine, or an original product label being tampered during counterfeiting and replaced altogether with a duplicate product label that mimics the characteristics of the original product label and therefore closely resembles the original product label, the present disclosure envisages a tamperproof, counterfeiting resistant security label, which in turn entails a specific set of characteristics, preferably design-related characteristics, which, given its conceptualization and designing, facilitates an early and easy detection of tampered and/or counterfeited products. Further, the security label envisaged by the present disclosure is truly resistant to tampering and counterfeiting in the sense that any tampering of the security label, i.e., any minuscule changes to even the location and the orientation of the security label is accurately identified via a pre-programmed yet standardized scanning process, thereby evidencing the onset of product tampering and/or product counterfeiting.

The security label, in accordance with the present disclosure, is affixed onto a product package or a product (or both) intended to be protected from tampering and consequential counterfeiting. Those skilled in the art would readily appreciate the fact that the security label could be selectively affixed either onto the product package itself or onto the underlying product, and that affixing of a product label on the product package or the underlying product, as recited in the present disclosure, is purely exemplary in nature and should therefore never be construed in a limiting sense. Alternatively, the security label could also be printed on the product package or the underlying product instead of being affixed.

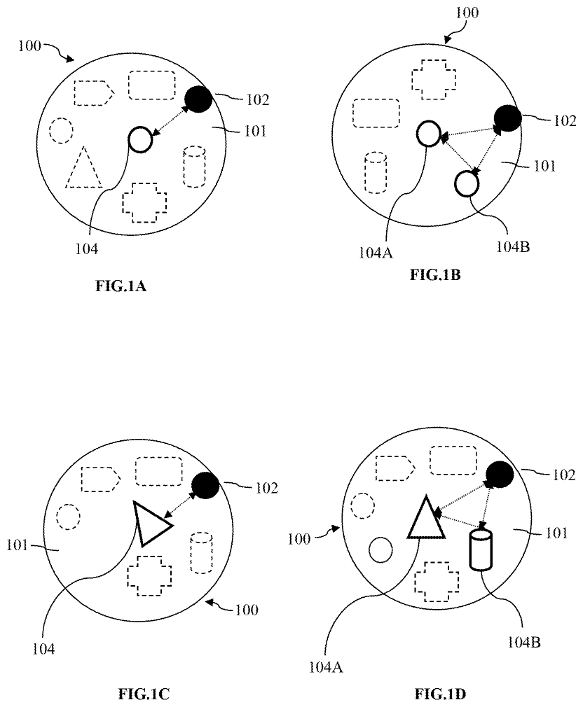

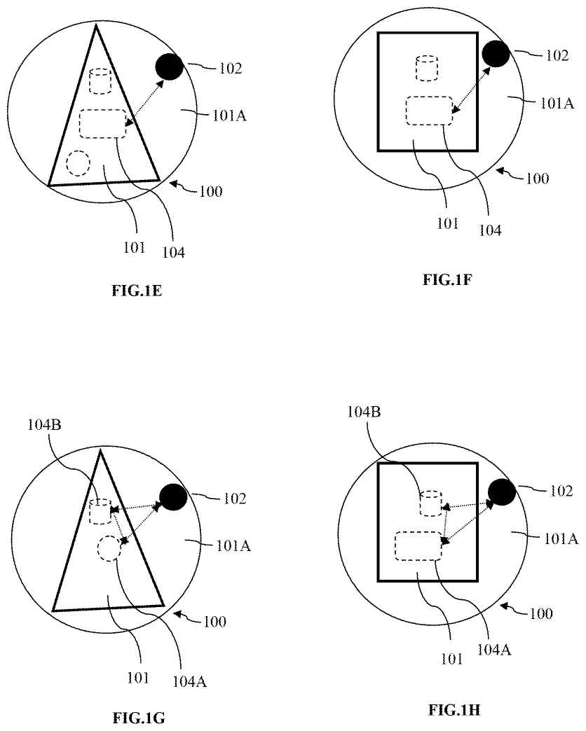

The security label envisaged by the present disclosure is illustrated in FIGS. 1A-1F. Referring to FIG. 1A, the security label 100 is shown as including a base layer. The base layer is generally created on or affixed onto the product package or the product (or both), which needs to be protected against tampering and consequential counterfeiting. The base layer is typically a liner, as is the case with most of the conventional product labels. The base layer, i.e., the liner is created using either white paper liners, or kraft paper liners, or clear polyester liners. And typically, a layer of adhesive is coated on the frontal/outer surface of the base layer such that a scannable security element 101—which enables verification of the authenticity of the security label 100—could be affixed onto a frontal/outer surface of the base layer, in combination with a front stock (label stock).

Further, in accordance with the present disclosure, the outer/frontal surface of the base layer constitutes the face stock or label stock (101A; FIG. 1E-FIG. 1F), which, as the name suggests, forms the visible portion of the security label 100. Typically, the face stock is affixed onto the upper/frontal surface of the base layer, using, a layer of adhesive, such that the face stock constitutes the outer/frontal surface of the base layer. The face stock, as described above, includes at least one security element 101 disposed therein. Essentially, the security element 101 entirely overlaps the face stock, thereby occupying the entire periphery of the face stock, as illustrated in FIGS. 1A-1D and rendering the entirety of the front stock 101A scannable. Further, as illustrated in FIGS. 1A-1D, the security element 101, the face stock underlying the security element 101, and the base layer underlying the combination of the face stock and the security element 101 are substantially circular in shape, thereby rendering the security label 100 also substantially circular in shape.

However, in the case of FIG. 1E, while face stock 101A and the base layer are substantially circular in shape, with the face stock 101A being affixed atop the base layer with a layer of adhesive (not shown in figures) so as to overlap the base layer in its entirety, the security element 101 is substantially triangular in shape and therefore overlaps with only a predetermined portion of the face stock 101A (as illustrated in FIG. 1E), with the remaining area of the face stock 101A incorporating, for example, non-scannable relevant product information. And, in such a case, only the substantially triangular security element 101 is rendered scannable out of the entire periphery of the face stock 101A.

Likewise, in the case of FIG. 1F, while face stock 101A and the base layer are substantially circular in shape, with the face stock 101A being affixed atop the base layer with a layer of adhesive (not shown in figures) so as to overlap the base layer in its entirety, the security element 101 is substantially rectangular in shape and therefore overlaps with only a predetermined portion of the face stock 101A (as illustrated in FIG. 1F), with the remaining area of the face stock 101A incorporating, for example, non-scannable relevant product information. And, in such a case, only the substantially rectangular security element 101 is rendered scannable out of the entire periphery of the face stock 101A. Further, FIG. 1G illustrates (a) substantially triangular face stock 101 constituting a first indicia 104A and a second indicia 104B, whereas FIG. 1H illustrates (a) substantially rectangular face stock 101 constituting a first indicia 104A and a second indicia 104B.

The face stock, in accordance with the present disclosure, could be made of either paper, or film, or foil, or fluorescent veneer, or holographic veneer or wood veneer. It is possible that the face stock is affixed onto the upper/frontal surface of the base layer with a layer of adhesive, as explained earlier. Alternatively, the face stock could be printed on the upper/frontal surface of the base layer, with the possibility that the security element 101 is also printed onto the face stock using well-known multi-layer printing technologies.

In accordance with the present disclosure, the security element 101 disposed on the frontal/outer surface of the base layer, i.e., the face stock, essentially denotes the scannable area of the face stock such that the security element, when scanned by a pre-programmed scanning device, provides an attestation of the authenticity and genuineness of the security label 100. In accordance with the present disclosure, the security element 101 disposed upon the face stock includes a predetermined indicium 104—the indicium 104 being, preferably, a recognizable geometric object. The indicium 104 essentially forms a part of the security element 101 and, by extension, is located within the periphery of the security label 100. Typically, in accordance with the present disclosure, both the orientation and the positioning of the indicium 104 is decided with reference to a randomly designated reference point located on or within the periphery of the security label 100. Throughout the present disclosure, the use of the expression ‘a randomly designated reference point located within the periphery of the security label,’ is also intended to cover and explain the possibility of the reference point located on the periphery of the security label. And the term ‘within the periphery’ is intended to be used in a broader sense so as to encompass the expression ‘on the periphery’ as well.

In accordance with the present disclosure, the randomly designated reference point 102 located on or within the periphery of the security label 100, is invisible and non-comprehendible to the naked human eye as well as (to) scanning devices which have not been preconfigured to scan the security label envisaged by the present disclosure and identify the positioning of the reference point 102 thereon, given that the reference point is programmatically designated at random and such a randomized selection of the reference point is never made apparent by way of explicit marking. In accordance with the present disclosure, whenever a product package or an underlying product (or both) is to be affixed with a security label 100 envisaged by the present disclosure, the security label 100 is programmatically conceptualized, designed, and created in a computer-implemented system embodying executable computer program code specially programmed to create security labels in line with the teachings of the present disclosure. Typically, at first, the dimension of the security label 100 is programmatically determined. As shown in FIGS. 1A-1H, the security label 100 is essentially a recognizable geometric object, including but not restricted to a circle, a rectangle, a square, and a triangle. It is within the scope of the present disclosure that any geometric object with a predefined shape, size, and boundaries is selected for conceptualizing and designing the security label 100.

Further, the dimensions of the thus selected security label 100 are programmatically measured. The programmatic measurement of the dimensions of the security label 100 includes measuring at least the length and breadth of the (thus selected) security label 100. And in case the security label 100 is a circle (as illustrated in FIGS. 1A-1F), at least the circumference and the diameter of the circle are programmatically measured. Subsequently, a random reference point 102 is programmatically generated such that the thus generated random reference point 102 is located within the periphery (and in case of the security label 100 being a circle, the circumference) of the security label 100. As discussed above, even if the random reference point 102 is located right on the periphery of the security label 100, it is considered, for all practical purposes, to be not violating the periphery of the security label 100 and therefore as located within the periphery of the security label 100.

In accordance with the present disclosure, since the random reference point 102 is programmatically selected, such a selection is rendered invisible to the human eye and to any other uninitiated, i.e., not specifically pre-programmed scanning devices, which have not been configured to identify an otherwise invisible reference point 102. Moreover, it is possible that the reference point 102 is located, programmatically, either on the edge of the periphery of the security label 100 or inside the periphery of the security label 100, as discussed above, with the only criteria being that the selected reference point 102 should be internal to the security label 100. Further, in accordance with the present disclosure, (at least one) indicium 104 is programmatically selected and disposed within or on the periphery of the security label 100, with the disposition of the indicium 104 correlated to the positioning (disposition) of the reference point 102 on or within the periphery of the security label 100. Preferably, the indicium 104 is disposed within the periphery of the security label 100, at an angle with reference to the reference point 102, or at a particular distance from the position of the reference point 102.

In a preferred embodiment of the present disclosure illustrated in FIG. 1A, the security label 100 constitutes a security element 101. The security element 101 constitutes an indicium 104 disposed within the security label 100. As shown in FIG. 1A, the security element 101 is a circle and overlaps the base layer and the face stock in its entirety. The indicium 104 is also a circle having a comparatively smaller diameter and circumference. As shown in FIG. 1A, the circumference of the front stock incorporating the security element 101 is equivalent to the circumference of the security label 100, such that the front stock—constituting the security element 101 overlaps the entirety of the outer/frontal surface of the base layer of the security label 100.

As shown in FIG. 1A, the indicium 104 is disposed at a particular length from the randomly selected reference point 102 located on or within the periphery of the security label 100. Alternatively, the indicium 104 is disposed within the periphery of the security label 100 such that the indicium 104 is located at a particular angle with reference to the positioning of the reference point 102. Alternatively, the indicium 104 is oriented in a predetermined manner with reference to the positioning of the reference point 102. For example, if the indicium 104 was a triangle (as shown in FIG. 1C), then the base of the triangle could have been titled at a particular angle with reference to the reference point 102, or the triangle could have been oriented in a particular manner (clockwise or counter-clockwise) with reference to the positioning of the reference point 102.

In accordance with the present disclosure, the security label 100 is characterized by the randomly selected reference point 102 located within or on the periphery of the security label 100, thereby rendering the reproduction of the security label 100 impossible since the reference point 102 is never explicitly marked on the security label 100 and therefore remains invisible to the naked human eye as well as to conventional scanning devices which have not been pre-programmed to scan and identify an otherwise invisible reference point 102. For instance, if the security label 100 is a circle, then the reference point 102 is, in an exemplary sense, determined to be located at an angle of ‘sixty’ degrees with reference to the center of the circle, and the indicium 104 is determined to be at an angle of ‘forty-five’ degrees from the position of the reference point 102. Or alternatively, if the reference point 102 is determined to be at an angle of ‘sixty’ degrees with reference to the center of the circle, then the indicium 104 is determined to be at a distance of ‘two’ centimeters from the reference point 102. It is pertinent to note that the positioning of the reference point 102 vis-à-vis the position of the indicium 104 occurs programmatically, with an inference being programmatically created between the position of the indicium 104 and the positioning of the reference point 102. And, therefore, in the case where the security label 100, comprising a circle as the security element 101, reference point 102 at an angle of ‘sixty’ degrees from the centre of the circle (security element), and indicium 104 positioned at an angle of ‘forty five’ degrees from the reference point 102 and/or at a distance of ‘two’ centimetres from the position of the reference point 102, is removed, and if an attempt is made towards affixing the hitherto removed security label 100 back onto the product package (ostensibly after replacing the genuine product with a counterfeit product), then, since the reference point 102 is rendered invisible to the human eye, and since the presence of a reference point 102 within the periphery of the security label 100 is never made apparent (the reference point 102 remaining unmarked and thus unnoticeable, even to the naked human eye as well as a conventional scanning device which has not been pre-programmed to identify such reference points which have not been explicitly marked), it is impossible to put back (re-affix) the security label 100 in the same orientation such that the reference point 102 remains at an angle of ‘sixty’ degrees from the centre of the circle (security element 101), and the indicium 104 remains at an angle of ‘forty five’ degrees from the reference point 102 and/or at a distance of ‘two’ centimetres from the position of the reference point 102. The integration of an invisible reference point 102 and the conceptualization of a pattern indicative of the disposition of the indicium 104 with reference to the disposition of the reference point 102, both indicium 104 and the reference point 102 internal to the security label, and the correlation (represented in the form of pattern) between the invisible reference point 102 and the indicium 104 not apparent and therefore non-comprehendible to both a naked human eye and conventional scanning devices not been pre-programmed to scan and identify the invisible reference point 102, and consequentially the relationship between the positioning of the indicium 104 and the reference point 102, renders the security label 100 tamperproof and ensures that even if the security label 100 is removed from the product package and re-affixed exactly at the same place where it was originally affixed, it is highly unlikely and rather impossible that the tampering of the security label 100 remains undetected, for it is highly unlikely that the orientation of the security label 100 (i.e., the positioning of the reference point 102 vis-à-vis the positioning of the indicium 104) would have remained unchanged and the reference point 102 would have remained at an angle of ‘sixty’ degrees from the centre of the circle (security element), and the indicium 104 would have remained at an angle of ‘forty five’ degrees from the reference point 102 and/or at a distance of ‘two’ centimetres from the position of the reference point 102.

In accordance with the present disclosure, the correlation (represented in the form of pattern) between the reference point 102 disposed within or on the periphery of the security label 100 and the positioning of the indicium 104 with reference to the disposition of the reference point 102 is programmatically stored in a predetermined database accessible to the scanning device pre-programmed via the execution of the computer program product envisaged by the present disclosure, to scan and identify the invisible reference point 102 and draw an inference involving the positioning of the indicium 104 relative to the positioning of the (invisible) reference point 102 In accordance with the present disclosure, disposition of the reference point 102 within or on the periphery of the security label 100, in combination with the positioning of the indicium 104 relative to the positioning of the reference point 102, constitutes a signature unique to the security label 100, such that when the security label 100 affixed onto a product package is tampered with an obvious intention of indulging in counterfeiting, the characteristics of the security label 100 including at least the disposition of the reference point 102 within (or on) the periphery of the security label 100 and the positioning of the indicium 104 with reference to the positioning of the reference point 102 is also consequentially modified, rather unwittingly, since the reference point 102 is not explicitly marked and is therefore rendered invisible, and since the inference between the positioning of the indicium 104 relative to the positioning of the reference point 102 cannot be duplicated given that the reference point 102 itself is invisible, thereby evidencing the tampering and possible counterfeiting of the product package.

Further, the reference point 102 disposed within the periphery of the security label 100 and the positioning of the indicium 104 with reference to the disposition of the reference point 102, in combination characterize a signature (not shown in figures) unique to the security label 100. By extension, the signature thus characterized would be rendered unique to the product package on which the security label 100 is affixed. And therefore, the security label 100, when affixed onto a product package, renders the product package unique given the unique nature of the security label affixed thereto. Further, the signature unique to the security label is programmatically linked to a product ID (product identifier; PID) associated with the said product package, such that the product ID and signature pair uniquely identifies the product package. In accordance with a preferred embodiment of the present disclosure, the product ID associated with the product package is at least one of a barcode, a Quick Response (QR) code, and a Radio-Frequency Identification (RFID) tag. As described above, the product ID associated with the product package is programmatically linked to the signature unique to the product package; the unique signature characterized by the correlation (represented by the pattern) between the reference point 102 disposed within (or on) the periphery of the security label 100 and the positioning of the indicium 104 with reference to the disposition of the reference point 102. Essentially, the product ID is a scannable static code comprising either a numeric or an alpha-numeric array, whereas the signature (linked to the product ID) is dynamic in nature in that the signature changes based on the positioning of the reference point 102 within (or on) the periphery of the corresponding security label 100 and the consequential positioning of the indicium 104 (or the first indicia 104A and second indicia 104B; FIG. 1B) within the periphery of the security label 100. Essentially, in accordance with the present disclosure, the static product ID is paired with the unique dynamic signature, so as to facilitate verification of the authenticity of the product upon with the security label 100 has been affixed.

And in accordance with the present disclosure, typically, both the security label 100 and the product ID are affixed onto the product package. In certain prior-art systems and methods, the positioning of the product ID acts as a reference point for the positioning of an indicium or a set of indicia within a prior-art product label, with the positioning of the product ID playing a vital role in the creation of the unique signature characterizing the (prior-art) product label. However, in the case of the security label envisaged by the present disclosure, the product ID and the positioning thereof is never used as a reference for positioning the indicium 104 or a set of indicia within the security label 100. Consequentially, the product ID and the positioning thereof has no role in the creation of the unique signature characterizing the security label 100, with the unique signature characterizing the security label 100 being created solely based on the disposition of the reference point 102 on or within the periphery of the security label 100—and thus internal to the security label 100—and the disposition of the indicium 104 with reference to the said reference point 102. Further, in accordance with the present disclosure, even though the product ID plays no role in the creation of a unique signature characterizing the security label 100, the product ID of the product package is programmatically linked to the unique signature characterizing the security label affixed on the product package. A database stores the product ID and the unique signature corresponding to the product package as a product ID-signature pair uniquely identifying the said product package and validating the authenticity of the said product package.

Further, when the product package is dispatched, preferably to a transit point (for example a warehouse), after having been affixed with the product ID and the security label 100, scanning of the said product package at the said transit point entails the use of a scanning device that has been specifically configured, via the computer program product envisaged by the present disclosure, to read and identify the product ID and the security label 100, and to secondly determine, ostensibly by way of scanning the disposition of the reference point 102 within (or on) the periphery of the security label 100, the disposition of the indicium 104 relative to the positioning of the reference point 102, the pattern representative of the correlation between the disposition of the indicium 104 and the reference point 102, and the unique signature represented by the pattern of disposition of the indicium 104 relative to the disposition of the reference point 102.

Essentially. the scanning device specifically configured via the computer program product envisaged by the present disclosure, would be pre-programmed to read the product ID affixed on the product package, read the security label 100 affixed on the product package, consult the database and determine if the product ID and the characteristics of the security label—i.e., the unique signature characterizing the security label, the unique signature, in turn. constituting a correlation (pattern) between the disposition of the reference point 102 on (or within) the periphery of the security label 100 and the positioning of the indicium 104 with reference to the (disposition of the) reference point 102—elicited from the process of scanning of the product package, are equivalent to the programmatically interlinked product ID and the unique signature, i.e., the product ID-signature pair stored in the database.

In accordance with the present disclosure, subsequent to seaming the product ID and the security label 100 affixed on the product package, the pre-programmed scanning device identifies, from the scanned security label 100, the characteristics of the unique signature characterizing the security label 100, the characteristics including the disposition of the reference point 102 within (or on) the periphery of the security label 100 and the positioning of the indicium 104 with reference to the disposition of the reference point 102 within (or on) the periphery of the security label (the positioning of the indicium 104 with reference to the disposition of the reference point 102, in turn, referencing either the distance between the indicium 104 and the reference point 102 or the angle of orientation of the indicium 104 with reference to the reference point 102 or both). Subsequently, the pre-programmed scanning device consults the database and considering the scanned product ID (affixed to the product package) as the ‘primary reference,’ identifies, on the database, an equivalent product ID. subsequently, the scanning device identifies the unique signature linked to the product ID stored on the database and subsequently elicits the unique signature referenced by the (stored) product ID. Further, the scanning device determines if the characteristics of the unique signature characterizing the security label 100, derived from scanning of the security label 100, are equivalent to the characteristics of the unique signature referenced by the (stored) product ID. Ostensibly, the scanning device determines if the product ID and the unique signature elicited by way of scanning are equivalent to any of the product 1D-unique signature pairs stored on the database. Typically, the equality between the signature elicited by way of scanning the security label 100 and the unique signature stored on the database is derived based on the characterizes (i.e., disposition of the reference point 102 within or on the periphery of the security label 100 and the positioning of the indicium 104 with reference to the disposition of the reference point 102 within the periphery of the security label) Essentially, the pre-programmed scanning device determines if the combination of the product ID and the unique signature referenced by the security label 100 identified by way of scanning the product package is equivalent to any of the combinations of product ID and unique signature stored on the database. And in an event the scanning device finds a match in the database for the scanned product ID and the security label, then the (corresponding) product package is designated as authentic and untampered. Otherwise, if the combination of the product ID and the security label, scanned from the product package, finds no match with (any of) the entries of the database, then the scanning device attributes such a lack of a match to a change in the disposition of the reference point on the security label and a consequential change in the positioning of the indicium within the security label—for the indicium is always positioned with reference to the disposition of the reference point—and designates the (corresponding) product package as being tampered and thus counterfeited, and accordingly generates a warning viewable on a display screen thereof.

As discussed earlier, the correlation (represented in the form of pattern) between the reference point 102 disposed within (or on) the periphery of the security label 100 and the positioning of the indicium 104 relative to the disposition of the reference point 102 forms a non-duplicable pattern, in turn, constituting the signature unique to the said security label 100. And, in turn, the security label 100 renders a product package on which it is affixed unique and sensitive to tampering and counterfeiting since the invisibility of the reference point 102 makes it impossible for the reference point 102, the correlation between the reference point 102 and the positioning of the indicium 104 relative to the disposition of the reference point 102, and the corresponding unique signature to be visually identified and duplicated.

Essentially, the disposition of the reference point 102 within (or on) the periphery of the security label 100 and the disposition of the indicium 104 with reference to the positioning of the reference point 102 is represented using numerical coordinates, for example, a first set of numerical coordinates. Further, since the disposition of the reference point 102 within (or on) the periphery of the security label 100 and the disposition of the indicium 104 with reference to the positioning of the reference point 102 constitute a signature unique to the security label 100, the coordinates, in this case, the first set of coordinates, representing the disposition of the reference point 102 within (or on) the periphery of the security label 100 and the disposition of the indicium 104 with reference to the positioning of the reference point 102, also direct to the unique signature corresponding to the security label 100.

For instance, if the security label 100 is in the shape of a circle, then the disposition of the reference point 102—the reference point 102, which, as described above, is rendered invisible to the naked human eye as well as conventional scanning devices which have not been pre-programmed to scan and read the security label 100—on the circle (the security label 100) is represented in terms of an angle formed within the circle, i.e., the reference point 102 is positioned at an angle of ‘ninety’ degrees within the periphery of the circle. Likewise, the positioning of the indicium 104 is represented either in terms of length, i.e., the indicium 104 is at a distance of ‘two’ centimeters from the reference point 102, or in terms of an angle formed with reference to the disposition of the reference point 102, i.e., the indicium 104 is positioned at an angle of ‘thirty’ degrees from the disposition of the reference point 102. And in accordance with the present disclosure, the angle referencing the location of the reference point 102 within the security label 100, the distance between the reference point 102 and the indicium 104, and the angle formed between the reference point 102 and the indicium 104 are represented in the form of (first set of) coordinates. And in a preferred embodiment, the (first set of) coordinates also represent the unique signature corresponding to the security label 100.

In accordance with the present disclosure, the scanning device is pre-programmed in the sense that it is configured to scan the product ID and the security label 100 affixed on the product package and derive therefrom the product ID and a plurality of characteristics including the location of the reference point 102 within the security label 100, the distance between the reference point 102 and the indicium 104 and/or the angle formed between the reference point 102 and the indicium 104 (the characteristics thus derived constituting the unique signature characterizing the security label 100). Subsequently, the scanning device consults the database and determines if there exists, in the database, a product ID (i.e., stored product ID equivalent product ID scanned from the security label 100 (i.e., scanned product ID). In case of a match being found in the database for the scanned product ID, the scanning device identifies the unique signature linked to the ‘stored’ product ID and determines if the characteristics of the unique signature linked to the ‘stored’ product ID, i.e., the location of the reference point 102 within the security label 100, the distance between the reference point 102 and the indicium 104 and/or the angle formed between the reference point 102 and the indicium 104, are equivalent to the characteristics derived from the scanning of the security label 100. In an event the unique signature linked to the ‘stored’ product ID is deemed not to be equivalent to the characteristics derived from the scanning of the security label 100, then the scanning device flags the product package underlying the security label 100 as tampered and thus counterfeited, and accordingly triggers the display of a warning message on a display screen (preferably embedded within the scanning device) highlighting that the product package is tampered and likely to be counterfeited. Otherwise, in an event the unique signature linked to the ‘stored’ product ID is deemed to be equivalent to the characteristics derived from the scanning of the security label 100, then the scanning device triggers the display a message affirming the authenticity of the product package.

In accordance with another embodiment of the present disclosure and as shown in FIGS. 1B and 1D, the security element 101 disposed within the security label 100 comprises at least two indicia 104A and 104B instead of the sole indicium. As was the case with the sole indicium, the (at least) two indicia 104A and 104B are also positioned within the security label 100 and with reference to the (disposition of the) invisible reference point 102 on the periphery of or within the security label 100. In the case of two indicia 104A and 104B, the signature unique to the security label 100 is characterized by the positioning of both the indicia (first indicia and second indicia; 104A and 104B respectively) with reference to the reference point 102 and the disposition of the reference point 102 on or within the periphery of the security label 100.

Likewise, in the case of two indicia 104A and 104B, the reference point 102 disposed within the periphery of the security label 100 and the positioning of each of the indicia 104A and 104B with reference to the (disposition of the) reference point 102 constitutes the signature unique to the (underlying) product package. And in such a case, the unique signature is characterized by the disposition of the reference point 102 on or within the periphery of the security label 100 and the positioning of the first indicia 104A and the second indicia 104B with reference to the (disposition of the) reference point 102. And further, the disposition of the reference point 102 on or within the periphery of the security label 100, in combination with the positioning of the first indicia 104A and the second indicia 104B with reference to the (disposition of the) reference point 102, forms a unique pattern representative of the said unique signature. Further, as was the case with the security label 100 comprising an indicium (104), the unique signature corresponding to the security label comprising the first indicia 104A and second indicia 104B is also programmatically linked to the product ID corresponding to the product package.

Further, the correlation between the reference point 102 disposed within the periphery of the security label 100 and the positioning of the first indicia 104A and the second indicia 104B with reference to the disposition of the reference point 102, the said correlation, in turn, constituting the unique signature is programmatically stored in the database after being interlinked to the corresponding product ID. And therefore, the database, in accordance with the present disclosure, stores as entries interlinked product ID and unique signature pairs, with the product ID referencing a particular product package and the unique signature characterizing the security label 100 affixed on the product package identified by the corresponding product ID.

In accordance with the present disclosure, the disposition of the reference point 102 within the periphery of the security label 100 and the disposition of the first indicia 104A and the second indicia 104B with reference to the reference point 102 are also represented using numerical coordinates, for example, a second set of numerical coordinates. For instance, if the security label 100 is in the shape of a circle, then the disposition of the reference point 102 on the circle (the security label 100) is represented in terms of an angle formed with the center of the circle, i.e., the reference point is positioned at an angle of ‘ninety’ degrees with reference to the center of the circle. Likewise, the positioning of each of the indicia (104A and 104B) is represented either in terms of the length, i.e., the first indicia 104A is at a distance of ‘two’ centimeters from the reference point 102, and the second indicia 104B is at a distance of ‘three’ centimeters from the reference point 102, or in terms of an angle formed with reference to the disposition of the reference point 102, i.e., the first indicia 104A is positioned at an angle of ‘fifty’ degrees from the disposition of the reference point 102, and the second indicia 104B is disposed at an angle of ‘fifteen’ degrees from the position of the reference point 102. And in a preferred embodiment, the said coordinates, i.e., the second set of coordinates, also represent the unique signature corresponding to the security label 100.

As was the case with the security label comprising the indicium (104), the scanning device, in the case of two indicia 104A and 104B, is (also) pre-programmed to read the product ID affixed on the product package, read the security label 102 affixed on the product package, consult the database and determine if the product ID and the characteristics of the security label—i.e., the unique signature referenced by the security label, which, in turn, constitutes the correlation between the disposition of the reference point within or on the periphery of the security label and the positioning of the first indicia and the second indicia within the security label and with reference to the disposition of the reference point—read via the process of scanning of the product package are equivalent to the programmatically interlinked product ID and the signature unique to the product package, stored in the database.

In accordance with the present disclosure, subsequent to scanning the product ID and the security label 100 affixed on the product package, the pre-programmed scanning device identifies, from the scanned security label 100, the characteristics of the unique signature characterizing the security label 100, the characteristics including the disposition of the reference point 102 within (or on) the periphery of the security label 100 and the positioning of the first indicia 104A and second indicia 104B with reference to the disposition of the reference point 102 (the positioning of the first indicia 104A and second indicia 104B with reference to the disposition of the reference point 102, in turn, referencing either the distance between the first indicia 104A and second indicia 104B and the reference point 102, or the angle of orientation of the first indicia 104A and second indicia 104B with reference to the reference point 102, or both).

Subsequently, the pre-programmed scanning device consults the database and considering the scanned product ID (affixed to the product package) as the ‘primary reference,’ identifies, on the database, an equivalent product ID. subsequently, the scanning device identifies the unique signature linked to the product ID stored on the database and subsequently elicits the unique signature referenced by the (stored) product ID. Further, the scanning device determines if the characteristics of the unique signature characterizing the security label 100, derived from scanning of the security label 100, are equivalent to the characteristics of the unique signature referenced by the (stored) product ID. Ostensibly, the scanning device determines if the product ID and the unique signature elicited by way of scanning are equivalent to any of the product ID-unique signature pairs stored on the database. Typically, the equality between the signature elicited by way of scanning the security label 100 and the unique signature stored on the database is derived based on the characterizes (i.e., disposition of the reference point 102 within or on the periphery of the security label 100 and the positioning of the first indicia 104A and second indicia 104B with reference to the disposition of the reference point 102). Essentially, the pre-programmed scanning device determines if the combination of the product ID and the unique signature referenced by the security label 100 identified by way of scanning the product package is equivalent to any of the combinations of the product ID and unique signature stored on the database. And in an event the scanning device finds a match in the database for the scanned product ID and the (corresponding) security label, in the form of a product ID-signature pair, then the (corresponding) product package is designated as authentic and untampered. Otherwise, if the combination of the product ID and the security label scanned from the product package finds no match with (any of) the entries of the database, then the scanning device attributes such a lack of match to a change in the disposition of the reference point on the security label and a consequential change in the positioning of either the first indicia or second indicia or both within the security label—for the first indicia 104A and second indicia 104B are always positioned with reference to the disposition of the reference point—and designates the (corresponding) product package as being tampered and thus counterfeited, and accordingly generates a warning message viewable on a display screen thereof.

In accordance with the present disclosure, in the case of two indicia (104A and 104B) disposed within the security label 100, the first indicia 104A could be positioned at a distance of ‘two’ centimeters from the position of the randomly selected reference point 102 located within (or on) the periphery of the security label 100, while the second indicia 104B could be positioned at a distance of ‘three’ centimeters from the position of the randomly selected reference point 102, thereby implying that the orientation, and in this case the distance, of the first indicia 104A and the second indicia 104B with reference to the disposition of the reference point 102 could be mutually different. Alternatively, it is also possible and within the scope of the present disclosure that both the first indicia 104A and the second indicia 104B are positioned at a distance of ‘five’ centimeters from position of the randomly selected reference point 102, thereby implying that the orientation, and in this case the distance, of the first indicia 104A and the second indicia 104B with reference to the disposition of the reference point 102 could be mutually equivalent. Likewise, it is also possible and within the scope of the present disclosure that the first indicia 104A is positioned at an angle of ‘thirty’ degrees from the position of the randomly selected reference point 102 located within the periphery of the security label 100, while the second indicia 104B is positioned at an angle of ‘forty-five’ degrees from the position of the randomly selected reference point 102.

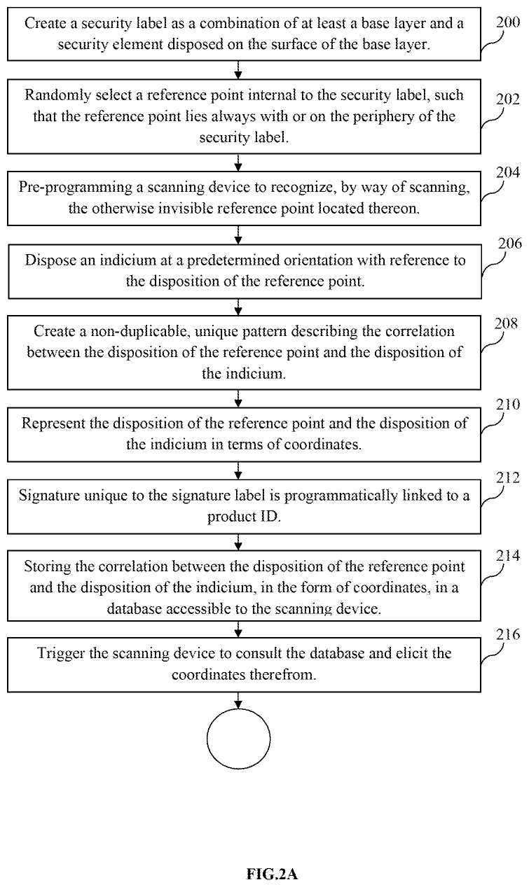

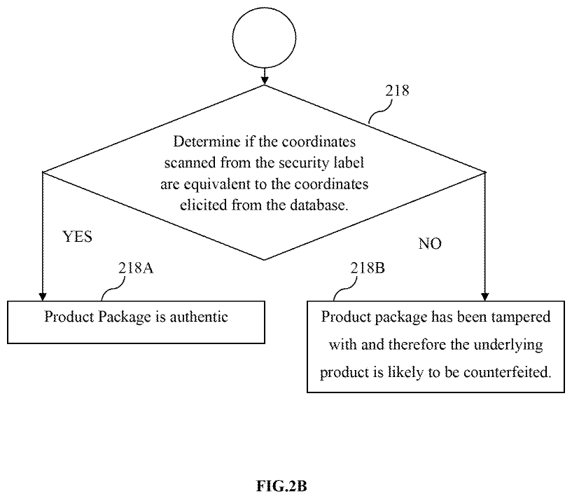

Referring to FIG. 2A and FIG. 2B in combination, there is shown a flowchart illustrating the steps involved in a computer-implemented method for detecting and verifying the authenticity of an item (a product or product package or both) by validating a security label affixed thereupon. The computer-implemented method is executed in part by a pre-programmed scanning device, with the remainder of the method executed by a processor controlling inter-alia the functionalities of a database. In accordance with the present disclosure, the execution of the method also entails the execution of the software program codes underlying the computer program product envisaged by the present disclosure. At step 200, a predetermined software program code is executed by the processor, as a part of the execution of the method, for creating a security label. The security label created at step 200 constitutes a base layer. Essentially, the base layer is a liner, as is the case with most of the conventional product labels. The base layer, i.e., the liner is created using either white paper liners, or kraft paper liners, or clear polyester liners. Further, a face stock, which forms the visible portion of the security label, is affixed onto the outer/frontal part of the base layer with a layer of adhesive. The face stock essentially includes at least one security element enabling verification of the authenticity of the product or product package or both, and optional product information. The face stock, in accordance with the present disclosure, could be made of either paper, or film, or foil, or fluorescent veneer, or holographic veneer or wood veneer. In accordance with the present disclosure, the face stock is the visible surface disposed atop the (frontal/outer surface of the) base layer such that the front stock entirely overlaps the base layer, and preferably incorporates the security element, with the security element disposed on the face stock such that the security element, as explained above, entirely overlaps the face stock, or alternatively overlaps at least a part of the face stock. Since the face stock is disposed atop the (frontal/outer surface of the) base layer, it is also possible that the front stock is described as constituting the frontal/outer surface of the base layer.

In accordance with the present disclosure, only the portion of the face stock containing the security element is rendered scannable. That is, if the security element overlaps the face stock in entirety, then the entire face stock is rendered scannable. Otherwise, if the security element overlaps only a portion of the face stock in entirety, then the portion of the face stock overlapped by the security element is rendered scannable. And in accordance with the present disclosure, the base layer, the front stock, and the security element could be printed atop one another using well-known multi-layer printing technologies, instead of the front stock being affixed upon the frontal/outer surface of the base layer and the security element disposed on the front stock.

In accordance with the present disclosure, the base layer and the face stock are substantially circular in shape, although it is possible that the base layer and the front stock entail other shapes including rectangle, square, triangle, and the like. Alternatively, it is possible that the base layer and the face stock entail randomized shapes having no pre-defined dimensions. However, for the sake of explanation, in the present disclosure, the base layer and the front stock are presumed to be substantially circular and equivalent in dimension. Preferably, the security element is also a recognizable geometric object having a predetermined dimension. For instance, the security element could be a circle, or a square, or a triangle, or a rectangle, or any other recognizable geometric object. Further, in the case where the security element entirely overlaps the front stock, it is possible that the dimension of the security element is in line with the dimension of the front stock.

Further. at step 202, a software program code pre-programmed to implement the step of programmatically identifying a randomly selected, internal reference point is executed. During the execution of step 202, the reference point is selected at random, with the only criterion being that the point thus selected should lie either within the pre-designated periphery of the security label or on the edge of the periphery of the security label. Further, the step 204, which is essentially executed at a scanning device, entails configuring or pre-programming the scanning device to recognize, by way of scanning the security label, the otherwise invisible reference point located thereon, i.e., either within the periphery of the security label or on the periphery of the security label. Subsequently, at step 206, which, in turn, is executed by the processor, at least one indicium is disposed on the security element, which is situated atop the front stock.

Preferably, the indicium is disposed within the periphery of the security element, at an angle with reference to the reference point located either within the periphery of the security label or on the edge of the periphery of the security label. Alternatively, the indicium could be disposed at a particular distance from the reference point. In accordance with the present disclosure, the security label is characterized by the randomly selected reference point located within or on the periphery of the security label, the reference point therefore regarded as being internal to the security label, and thereby rendering the reproduction of the security label impossible since the reference point is never explicitly marked on the security label and therefore remains invisible to the naked eye as well as to conventional scanning devices which have not been pre-programmed to scan and identify an otherwise invisible reference point. In addition, the security label is also characterized by a relationship, essentially in the form of a pattern, between the randomly selected reference point and the indicium constituted by the security label, in that the indicium is disposed either at a predetermined distance from the reference point (measurable in terms of the length) or at a predetermined angle with reference to the disposition of the reference point or both.

In accordance with the present disclosure, the correlation between the reference point disposed within or on the periphery of the security label, and the positioning of the indicium with reference to the disposition of the reference point is programmatically stored in the database controlled by the processor and is rendered accessible to the scanning device pre-programmed at step 204. The pattern describing the correlation between the disposition of the reference point and the disposition of the indicium is designated as non-duplicable (step 208) since the said pattern could not be conceptualized without having an understanding of the disposition of the reference point and the relationship—in terms of either a length or an angle or both—between the disposition of the reference point and the disposition of the indicium. And the relationship between the disposition of the reference point and the disposition of the indicium is never apparent to the naked human eye or a conventional scanning device since the disposition of the reference point on or within the periphery of the security label is never marked either explicitly or explicitly.

Further, in accordance with the present disclosure, the disposition of the reference point within the periphery of the security label and the disposition of the indicium with reference to the positioning of the reference point (within the periphery of the security label) are represented using numerical coordinates (Step 210). For instance, if the security label is a circle, then the disposition of the reference point—the reference point which, as described above, is rendered invisible to the naked eye, as well as conventional scanning devices which have not been pre-programmed to scan and read the security label—on the circle (the security label) is represented in terms of an angle formed within the circle, i.e., the reference point is positioned at an angle of ‘ninety’ degrees with respect to the center of the circle and within the periphery of the circle. Likewise, the positioning of the indicium is represented either in terms of length, i.e., the indicium is at a distance of ‘two’ centimeters from the reference point, or in terms of an angle formed with reference to the disposition of the reference point, i.e., the indicium is positioned at an angle of ‘thirty’ degrees from the disposition of the reference point. And in accordance with the present disclosure, the angle referencing the location of the reference point within the security label, the distance between the reference point and the indicium and the angle formed between the reference point and the indicium are represented in the form of coordinates, for example, a first set of coordinates as detailed in step 210. And in a preferred embodiment, the first set of coordinates is stored in the database, such that the said coordinates when programmatically analyzed constitute a unique signature referencing the security label.

As discussed above, the reference point disposed within the periphery of the security label and the positioning of the indicium with reference to the disposition of the reference point, in combination, characterizes a signature unique to the security label. And the security label, when affixed onto a product package, renders the product package unique, given the unique nature of the security label affixed thereto. Further, the signature unique to the security label is programmatically linked to a product ID (product identifier; PID) associated with the said product package (Step 212). In accordance with a preferred embodiment of the present disclosure, the product ID associated with the product package is at least one of a scannable barcode, a scannable Quick Response (QR) code, and a scannable Radio-Frequency Identification (RFID) tag. As described above, the product ID of the product package is programmatically linked to the unique signature referencing the security label affixed onto the product package; the unique signature comprising the correlation between the reference point disposed within the periphery of the security label, and the positioning of the indicium with reference to the disposition of the reference point within the periphery of the security label.

In accordance with the present disclosure, the database storing the correlation between the reference point disposed within or on the periphery of the security label and the positioning of the indicium with reference to the disposition of the reference point, in the form of a unique signature characterizing the security label, is rendered accessible to a scanning device that has been specifically pre-programmed (at step 204) to scan, and identify the positioning of the reference point on or within the periphery of the security label and the correlation (in terms of length or angle or both) between the positioning of the reference point and the positioning of the indicium within the security label. Alternatively, such a correlation is pre-stored, programmatically, in a local memory module of the pre-programmed scanning device. In such a case, pre-programming the scanning device involves programmatically storing such a correlation within the local memory module of the scanning device (Step 214).

Further, when the product package is dispatched, preferably to a transit point (for example a warehouse), after having been affixed with the product ID and the security label, scanning of the said product package at the said transit point entails the use of a scanning device that has been specifically configured, via the computer program product envisaged by the present disclosure, to firstly read and identify the product ID and the security label, and to secondly determine, ostensibly by way of scanning, the disposition of the reference point within (or on) the periphery of the security label, the disposition of the indicium relative to the positioning of the reference point, the pattern representative of the correlation between the disposition of the indicium and the reference point, and the unique signature represented by the pattern of disposition of the indicium relative to the disposition of the reference point.

Essentially, the scanning device specifically configured via the computer program product envisaged by the present disclosure, would be pre-programmed to read the product ID affixed on the product package, read the security label affixed on the product package, consult the database (step 216) and determine if the product ID and the characteristics of the security label—i.e., the unique signature characterizing the security label, the unique signature, in turn, constituting a correlation (pattern) between the disposition of the reference point 102 on (or within) the periphery of the security label and the positioning of the indicium 104 with reference to the (disposition of the) reference point—elicited from the process of scanning of the product package, are equivalent to the programmatically interlinked product ID and the unique signature, i.e., the product ID-signature pair stored in the database.

In accordance with the present disclosure, subsequent to scanning the product ID and the security label affixed on the product package, the pre-programmed scanning device identifies, from the scanned security label, the characteristics of the unique signature characterizing the security label, the characteristics including the disposition of the reference point within (or on) the periphery of the security label and the positioning of the indicium with reference to the disposition of the reference point within (or on) the periphery of the security label (the positioning of the indicium with reference to the disposition of the reference point, in turn, referencing either the distance between the indicium and the reference point or the angle of orientation of the indicium with reference to the reference point or both). Subsequently, the pre-programmed scanning device consults the database and considering the scanned product ID (affixed to the product package) as the ‘primary reference,’ identifies, on the database, an equivalent product D. Subsequently, the scanning device identifies the unique signature linked to the product ID stored on the database and elicits the unique signature referenced by the (stored) product ID. Further. the scanning device determines if the characteristics of the unique signature characterizing the security label, derived from scanning of the security label, are equivalent to the characteristics of the unique signature referenced by the (stored) product ID (Step 218). Ostensibly, the scanning device determines if the product ID and the unique signature elicited by way of scanning are equivalent to any of the product ID-unique signature pairs stored on the database. Typically, the equality between the signature elicited by way of scanning the security label and the unique signature stored on the database is derived based on the characterizes (i.e., disposition of the reference point within or on the periphery of the security label and the positioning of the indicium with reference to the disposition of the reference point within the periphery of the security label) Essentially, the pre-programmed scanning device determines if the combination of the product ID and the unique signature referenced by the security label identified by way of scanning the product package is equivalent to any of the combinations of product ID and unique signature stored on the database. And in an event the scanning device finds a match in the database for the scanned product ID and the security label, then the (corresponding) product package is designated as authentic and untampered (Step 218A). Otherwise, if the combination of the product ID and the security label, scanned from the product package, finds no match with (any of) the entries of the database, then the scanning device attributes such a lack of a match to a change in the disposition of the reference point on the security label and a consequential change in the positioning of the indicium within the security label—for the indicium is always positioned with reference to the disposition of the reference point—and designates the (corresponding) product package as being tampered and thus counterfeited (Step 218B), and accordingly generates a warning viewable on a display screen thereof.

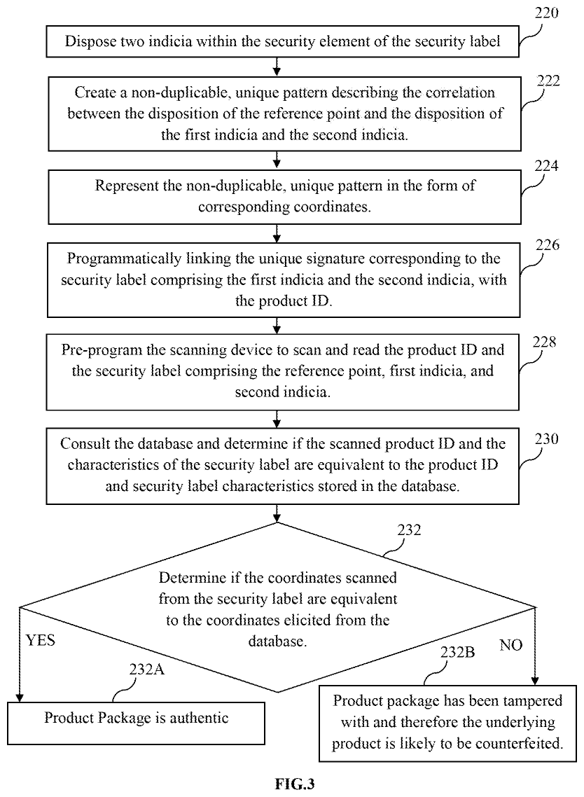

In accordance with another embodiment of the present disclosure, and as described in FIG. 3, the security element disposed within the security label comprises at least two indicia instead of the sole indicium (Step 220). As was the case with the sole indicium, the (at least) two indicia are also positioned within the security label and with reference to the (disposition of the) invisible reference point on the periphery of or within the security label. In the case of two indicia, the signature unique to the security label is characterized by the positioning of both the indicia (first indicia and second indicia) with reference to the reference point and the disposition of the reference point on or within the periphery of the security label.

Likewise, in the case of two indicia dispositioned within the security label, the reference point disposed within (or on) the periphery of the security label and the positioning of each of the indicia with reference to the (disposition of the) reference point constitutes the signature unique to the (underlying) product package. The unique signature, as described above, is characterized by the disposition of the reference point on or within the periphery of the security label and the positioning of the first indicia and the second indicia (within the security label) with reference to the (disposition of the) reference point. And further, the disposition of the reference point on or within the periphery of the security label, in combination with the positioning of the first indicia and the second indicia with reference to the (disposition of the) reference point, forms a unique pattern (Step 222) representing the unique signature. In accordance with the present disclosure, the disposition of the reference point within (or on) the periphery of the security label and the disposition of the first indicia and the second indicia with reference to the reference point are also represented using coordinates, for instance, a second set of coordinates (Step 224). Further, as was the case with the security label comprising an indicium, the unique signature corresponding to the security label comprising the first indicia and the second indicia is also programmatically linked (Step 226) to the product ID corresponding to the product package.

Further, the correlation between the reference point disposed within the periphery of the security label and the positioning of the first indicia and the second indicia with reference to the disposition of the reference point, which in turn constitutes the unique signature is programmatically stored in the database after being interlinked to the product ID corresponding to the product package on which the security label is affixed. And therefore, the database, in accordance with the present disclosure stores as entries, interlinked product ID and unique signature pairs, with the product ID referencing a particular product package and the unique signature characterizing the security label affixed on the product package identified by the product ID. For instance, if the security label is a circle, then the disposition of the reference point on the circle (the security label) is represented in terms of an angle formed within the circle, i.e., the reference point is positioned at an angle of ‘ninety’ degrees within the periphery of the circle. Likewise, the positioning of each of the indicia is represented either in terms of length, i.e., the first indicia is at a distance of ‘two’ centimeters from the reference point, whereas the second indicia is at a distance of ‘three’ centimeters from the reference point, or in terms of an angle formed with reference to the disposition of the reference point, i.e., the first indicia is positioned at an angle of ‘fifty’ degrees from the disposition of the reference point, whereas the second indicia is disposed at an angle of ‘fifteen’ degrees from the position of the reference point. And in a preferred embodiment, the second set of coordinates is stored in the database such that the said coordinates when analyzed generate the unique signature referencing the security label.

As was the case with the security label comprising the indicium, the scanning device in the case of two indicia is (also) pre-programmed to read the product ID affixed on the product package, read the security label affixed on the product package (Step 228), consult the database and determine if the product ID and the characteristics of the security label—i.e., the unique signature referenced by the security label, which, in turn, constitutes the correlation between the disposition of the reference point within or on the periphery of the security label, and the positioning of the first indicia and the second indicia within the security label and with reference to the disposition of the reference point—read via the process of scanning of the product package are equivalent to the programmatically interlinked product ID and the signature unique to the product package. stored in the database (Step 230).

In accordance with the present disclosure, subsequent to scanning the product ID and the security label affixed on the product package, the pre-programmed scanning device identifies, from the scanned security label, the characteristics of the unique signature characterizing the security label, the characteristics including the disposition of the reference point within (or on) the periphery of the security label and the positioning of the first indicia and second indicia with reference to the disposition of the reference point (the positioning of the first indicia and second indicia with reference to the disposition of the reference point, in turn, referencing either the distance between the first indicia and second indicia and the reference point, or the angle of orientation of the first indicia and second indicia 104B with reference to the reference point, or both).

Subsequently, the pre-programmed scanning device consults the database and considering the scanned product ID (affixed to the product package) as the ‘primary reference,’ identifies, on the database, an equivalent product ID. Subsequently, the scanning device identifies the unique signature linked to the product ID stored on the database and subsequently elicits the unique signature referenced by the (stored) product ID. Further, the scanning device determines if the characteristics of the unique signature characterizing the security label, derived from scanning of the security label, are equivalent to the characteristics of the unique signature referenced by the (stored) product ID. Ostensibly, the scanning device determines if the product ID and the unique signature elicited by way of scanning are equivalent to any of the product ID-unique signature pairs stored on the database. Typically, the equality between the signature elicited by way of scanning the security label and the unique signature stored on the database is derived based on the characterizes (i.e., disposition of the reference point within or on the periphery of the security label and the positioning of the first indicia and second indicia with reference to the disposition of the reference point). Essentially, the pre-programmed scanning device determines (Step 232) if the combination of the product ID and the unique signature referenced by the security label 100 identified by way of scanning the product package is equivalent to any of the combinations of the product ID and unique signature stored on the database. And in an event the scanning device finds a match in the database for the scanned product ID and the (corresponding) security label, in the form of a product ID-signature pair, then the (corresponding) product package is designated as authentic and untampered (Step 232A). Otherwise, if the combination of the product ID and the security label scanned from the product package finds no match with (any of) the entries of the database, then the scanning device attributes such a lack of match to a change in the disposition of the reference point on the security label and a consequential change in the positioning of either the first indicia or second indicia or both within the security label—for the first indicia and second indicia are always positioned with reference to the disposition of the reference point—and designates the (corresponding) product package as being tampered and thus counterfeited (Step 232B), and accordingly generates a warning message viewable on a display screen thereof.

In accordance with the present disclosure, in the case of two indicia disposed within the security label, the first indicia could be positioned at a distance of ‘two’ centimeters from the position of the randomly selected reference point located within the periphery of the security label, whereas the second indicia could be positioned at a distance of ‘three’ centimeters from the position of the randomly selected reference point, thereby implying that the orientation, and in this case the distance, of the first indicia and the second indicia with reference to the disposition of the reference point, could be mutually different. Alternatively, it is also possible and within the scope of the present disclosure that both the first indicia and the second indicia are positioned at a distance of ‘five’ centimeters from the position of the randomly selected reference point, thereby implying that the orientation, and in this case the distance, of the first indicia and the second indicia with reference to the disposition of the reference point, could be mutually equivalent. Likewise, it is also possible and within the scope of the present disclosure that the first indicia is positioned at an angle of ‘thirty’ degrees from the position of the randomly selected reference point located within the periphery of the security label, whereas the second indicia is positioned at an angle of ‘forty-five’ degrees from the position of the randomly selected reference point.

### TECHNICAL ADVANTAGES

The technical advantages envisaged by the present disclosure include the realization of a tamperproof, counterfeiting resistant product label. The product label envisaged by the present disclosure, when affixed onto a product package, allows for any tampering and the consequential counterfeiting of the product package to be immediately identified. Further, the product label (also referred to as a ‘security label’ given its tamperproof and anti-counterfeit characterization), The product label envisaged by the present disclosure is characterized by an internal reference parameter, based on which the features of the product label are developed. For instance, the product label includes an internal ‘reference point,’ which, as the name suggests, is disposed internally within the product label and is used as a reference for disposing identifiable and scannable indicia within (the) periphery of the product label. The programmatic, i.e., computer program-driven selection of the reference point, and disposition of the thus selected reference point strictly within the periphery of the product label renders the reference point invisible to a naked human eye as well as to conventional scanning devices which have not been specifically pre-programmed to scan for and identify invisible reference points. Further, in accordance with the present disclosure, the product label is characterized in such a way that the indicia disposed within the product label is always positioned/oriented with reference to the otherwise invisible reference point. That is, each of the indicium dispositioned within the periphery of the product label is implicitly and discretely linked to the positioning of the reference point such that a change in the disposition of the reference point affects the disposition of each of the indicia and vice-versa. Such a linking would ostensibly involve determining the length or angular orientation between the positioning of the reference point and the indicium, with a change in the positioning of the former affecting the positioning of the latter, and such a change in the positioning being regarded as a cue indicative of product label tampering and product counterfeiting.

Essentially, a change in the disposition of the reference point on the periphery of the product label unambiguously points to unauthorized removal and subsequent re-affixing of the product label, most often with ulterior motives including counterfeiting. In accordance with the present disclosure, the product label is characterized such that the disposition of the reference point (on or within the periphery of the product label) and the disposition of each indicium with reference to the disposition of the reference point is programmatically correlated and represented in the form of a signature unique to the product label and ostensibly to the underlying product package. And therefore, when the product label is removed and subsequently re-affixed, ostensibly during the process of tampering and counterfeiting, such a process (of removing and re-affixing the product label) would have been carried out in obliviousness to the presence of the reference point and the correlation between the positioning of the reference point and the indicium, for the presence of the reference point and the correlation between the positioning of the indicium with reference to the positioning of the reference point is never explicitly marked, and is rendered invisible to the naked eye as well as for conventional scanning devices which have not been pre-programmed to scan for and identify an invisible reference points and draw orientation related inferences between the otherwise invisible reference point and each of the indicia.

The product label envisaged by the present disclosure, as explained hitherto, creates a product label embodying an invisible reference point internal to the product label, draws positional inferences between an otherwise invisible reference point and the indicia (or at least an indicium) disposed within the product label, stores in a database such an inference in the form of a unique signature characterized by positional coordinates, programs a scanning device to scan the product label and derive the said positional inferences (between the reference point and the indicia) by way of scanning the product label and to compare the derived positional inferences with the counterparts stored in the database; with a mismatch between the two inferences point to a tampering of the product label and the possible counterfeiting of the underlying product.

What is claimed is:

1. A security label, said security label when affixed onto an item, configured to enable verification of authenticity of said item, said security label comprising:
a base layer; and
at least one security element disposed on a surface of said base layer, said security element comprising at least one indicium formed on said surface of said base layer for verifying the authenticity of said item, wherein said indicium is oriented with reference to at least one randomly generated reference point disposed internally within said security label, wherein said reference point is invisible to a naked eye, and wherein an orientation of said indicium on said surface with reference to said randomly generated, invisible reference point internal to said security label, renders said security label unique to said item.

2. The security label as claimed in claim 1, wherein said orientation of said indicium on said surface with reference to said randomly generated, invisible reference point, generates a non-duplicable pattern unique to said security label, and thereby renders said security label unique to said item.

3. The security label as claimed in claim 1, wherein said orientation of said indicium with reference to said randomly generated, invisible reference point, is represented using a first set of coordinates, and wherein said first set of coordinates are electronically linked to a product identifier (PID) affixed onto said item, and wherein said product identifier is disposed in proximity to said security label, and on said item.

4. The security label as claimed in claim 3, wherein said randomly generated, invisible reference point is identifiable and scannable only via a scanning device pre-programmed with said first set of coordinates, and wherein said scanning device is configured to determine, by way of scanning, said orientation of said indicium with reference to said randomly generated, invisible reference point, on said security label, and derive coordinates thereof.

5. The security label as claimed in claim 4, wherein said coordinates derived by said scanning device are compared with said first set of coordinates to verify the authenticity of said security label and said item.

6. The security label as claimed in claim 3, wherein said first set of coordinates indicate at least one of a distance between said indicium and said randomly generated, invisible reference point, and an angle of orientation of said indicium with respect to said randomly generated, invisible reference point.

7. The security label as claimed in claim 1, wherein said security element comprises at least two indicia formed on said surface of said base layer for verifying the authenticity of said item, wherein each of said indicia are oriented on said surface, with reference to said randomly generated, invisible reference point disposed internally within said security label, such that said orientation of each of said indicia with reference to said reference randomly generated, invisible reference point internal to said security label, generates a second non-duplicable pattern and thereby renders said security label unique to said item.

8. The security label as claimed in claim 7, wherein said orientation of each of said indicia with reference to said reference randomly generated, invisible reference point is mutually different.

9. The security label as claimed in claim 7, wherein orientation of each of said indicia with reference to said reference randomly generated, invisible reference point is mutually equivalent.

10. The security label as claimed in claim 7, wherein said orientation of each of said indicia with reference to said randomly generated, invisible reference point, is represented using a second set of coordinates, and wherein said second set of coordinates are electronically linked to said product identifier (PID) affixed onto said item, and wherein said randomly generated, invisible reference point is identifiable and verifiable via a second scanning device pre-programmed with said second set of coordinates.

11. The second scanning device as claimed in claim 10, wherein said second scanning device is configured to determine, by way scanning, said orientation of each of said indicia with respect to said randomly generated, invisible reference point on said security label, and determine coordinates representative of said orientation, and compare determined coordinates with said second set of coordinates to authenticate said item.

12. A method for detecting verifying the authenticity of an item by validating a security label affixed onto said item, said method comprising the following steps:
creating said security label as a combination of a base layer and at least one security element disposed on a surface of said base layer;
programmatically identifying, at random, at least one reference point within a periphery of said security label, such that randomly selected reference point is internal to said security label;
rendering said randomly selected reference point invisible to a human eye, and thereby creating a randomly generated, invisible reference point, and configuring said randomly generated, invisible reference point to be identifiable and scannable only via a pre-programmed scanning device; and
creating at least one indicium on said surface of said base layer, and positioning said indicium at a predetermined orientation with reference to said randomly selected, invisible reference point internal to said security label, such that said orientation of said indicium on said surface, with reference to said randomly generated, invisible reference point internal to said security label, renders said security label unique to said item.

13. The method as claimed in claim 12, wherein the step of positioning said indicium at a predetermined orientation with reference to said randomly selected, invisible reference point internal to said security label, further includes the step of generating a non-duplicable pattern representative of said orientation and unique to said security label.

14. The method as claimed in claim 12, wherein the step of positioning said indicium at a predetermined orientation with reference to said randomly selected, invisible reference point internal to said security label further includes the step of representing said orientation using a first set of coordinates, and electronically linking said first set of coordinates to a product identifier (PID) affixed onto said item, such that said first set of coordinates are identifiable as corresponding to said product identifier.

15. The method as claimed in claim 12, wherein the step of configuring said randomly generated, invisible reference point to be identifiable and scannable only via a pre-programmed scanning device, further includes the following steps:
pre-programming said scanning device by storing therein said first set of coordinates;
configuring said scanning device to determine, by way of scanning, said orientation of said indicium with reference to said randomly generated, invisible reference point, on said security label, and determine coordinates thereof, based on said scanning of said orientation of said indicium with reference to said randomly generated, invisible reference point, on said security label.

16. The method as claimed in claim 15, wherein the method further includes the step of triggering at scanning device, a comparison between said first set of coordinates and said coordinates determined by said scanning device, and verifying said security label to be authentic in an event said coordinates determined by said scanning device are equivalent to said first set of coordinates.

17. The method as claimed in claim 14, wherein the method further includes the step of indicating at least one of a distance between said indicium and said randomly generated, invisible reference point, and an angle of orientation of said indicium with respect to said randomly generated, invisible reference point, as said first set of coordinates.

18. The method as claimed in claim 12, wherein the method further includes the following steps:
creating at least two indicia on said surface of said base layer;
positioning each of said indicia at a predetermined orientation, with reference to said randomly selected, invisible reference point internal to said security label, such that said orientation of each of said indicia with reference to said randomly generated, invisible reference point internal to said security label, generates a second non-duplicable pattern, thereby rendering said security label unique to said item;
representing said orientation of each of said indicia with reference to said randomly generated, invisible reference point, using a second set of coordinates;
electronically linking said second set of coordinates to said product identifier (PID) affixed onto said item, and rendering said randomly generated, invisible reference point is identifiable and verifiable via a second scanning device pre-programmed with said second set of coordinates; and
configuring said second scanning device to determine, by way of scanning, said orientation of each of said indicia with respect to said randomly generated, invisible reference point on said security label;
determining coordinates representative of said orientation of each of said indicia with respect to said randomly generated, invisible reference point, on said security label;
triggering, at said second scanning device, a comparison between said second set of coordinates with said coordinates determined by said second scanning device; and
verifying said security label to be authentic in an event said coordinates determined by said second scanning device are equivalent to said second set of coordinates.

19. The method as claimed in claim 18, wherein the step of positioning each of said indicia at a predetermined orientation, with reference to said randomly selected, invisible reference point internal to said security label, further includes the step of positioning each of said indicia at mutually different orientations.

20. The method as claimed in claim 18, wherein the step of positioning each of said indicia at a predetermined orientation, with reference to said randomly selected, invisible reference point internal to said security label, further includes the step of positioning each of said indicia at mutually equivalent orientations.
